(19) United States
(12) Patent Application Publication
(10) Pub. No.: US 2025/0172675 A1
(43) Pub. Date: May 29, 2025

(54) TIME-OF-FLIGHT LIGHT EVENT DETECTION CIRCUITRY AND TIME-OF-FLIGHT LIGHT EVENT DETECTION METHOD

(71) Applicant: Sony Semiconductor Solutions Corporation, Atsugi-shi, Kanagawa (JP)

(72) Inventor: Daniel VAN NIEUWENHOVE, Stuttgart (DE)

(73) Assignee: Sony Semiconductor Solutions Corporation, Atsugi-shi, Kanagawa (JP)

(21) Appl. No.: 18/836,365

(22) PCT Filed: Feb. 2, 2023
(86) PCT No.: PCT/EP2023/052524

§ 371 Date: Aug. 7, 2024

(30) Foreign Application Priority Data
Feb. 14, 2022 (EP) 22156579.9

(51) Int. Cl. G01S 7/4915; G01S 7/481; G01S 17/894

(52) U.S. Cl. CPC G01S 7/4915; G01S 7/4816; G01S 17/894

(57) ABSTRACT

The present disclosure generally pertains to time-of-flight light event detection circuitry configured to: determine, in a macropixel mode, for a first frame for a first predetermined time period, light events of light being incident on a first light detection element; determine, in the macropixel mode, for the first frame for a second predetermined time period, light events of light being incident on a second light detection element; and determine, in a window mode, based on the macropixel mode, for a second frame after the resulting first frame, a third time period, in which light events are to be detected.

### TECHNICAL FIELD

The present disclosure generally pertains to time-of-flight light event detection circuitry and a time-of-flight light event detection method.

### TECHNICAL BACKGROUND

Generally, time-of-flight (ToF) cameras are known.

It may be distinguished between indirect ToF (iToF) and direct ToF (dToF).

In iToF, a phase-shift of emitted light is measured with a demodulation signal and the phase-shift is indicative of a distance from the camera to the object. Current-assisted photonic demodulators (CAPDs) may be used for carrying out an iToF measurement.

In dToF, the distance is directly measured by measuring a time of flight which emitted light needs to return to the camera after reflection at a scene (e.g. an object or region of interest). Basically, dToF is based on a counting of photons and assigning the counted photons to a time bin in a histogram, wherein the time bin may correspond to a time period after emission of light (by a respective pulsed light source, for example).

Although there exist techniques for carrying out a ToF measurement it is generally desirable to provide time-of-flight light event detection circuitry and a time-of-flight light event detection method.

### SUMMARY

According to a first aspect, the disclosure provides time-of-flight light event detection circuitry configured to:
determine, in a macropixel mode, for a first frame for a first predetermined time period, light events of light being incident on a first light detection element;
determine, in the macropixel mode, for the first frame for a second predetermined time period, light events of light being incident on a second light detection element; and
determine, in a window mode, based on the macropixel mode, for a second frame after the resulting first frame, a third time period, in which light events are to be detected.

According to a second aspect, the disclosure provides a time-of-flight light event detection method comprising:
determining, in a macropixel mode, for a first frame for a first predetermined time period, light events of light being incident on a first light detection element;
determining, in the macropixel mode, for the first frame for a second predetermined time period, light events of light being incident on a second light detection element; and
determining, in a window mode, based on the macropixel mode, for a second frame after the resulting first frame, a third time period, in which light events are to be detected.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1a depicts an image sensor including SPADs which constitute a macropixel, wherein an equal amount of circuits are foreseen each driven at a specific time period;

FIG. 1b depicts the image sensor of FIG. 1a, wherein each circuit of the former macropixel is driven at the same time period which has been determined in a previous frame;

FIG. 2 depicts a further embodiment of determining the time periods for the SPADs, whereby only the middle SPADS operate as macropixel and top and bottom SPADS as individual sensors;

FIG. 3a depicts a histogram which is generated by the macropixel of FIG. 1a and a plurality of histograms which are generated by the single pixels of FIG. 1b;

FIG. 3b depicts ToF light detection method according to the present disclosure in which the histograms of FIG. 3a are produced and processed;

FIG. 4 depicts a further ToF light detection method according to the present disclosure;

FIG. 5 depicts a further ToF light detection method according to the present disclosure in which it is decided whether each histogram has a peak;

FIG. 6 depicts a further ToF light detection method according to the present disclosure, wherein, if each histogram has a peak, the selected time period is refined;

FIG. 7 depicts a further ToF light detection method according to the present disclosure, wherein, if not each histogram has a peak, the time periods are refined based on surrounding pixels;

FIG. 8 shows a ToF pixel 70 according to the present disclosure;

FIG. 9 illustrates a ToF imaging system 80 according to the present disclosure; and

FIG. 10 depicts a further embodiment of a ToF light detection method according to the present disclosure.

### DETAILED DESCRIPTION OF EMBODIMENTS

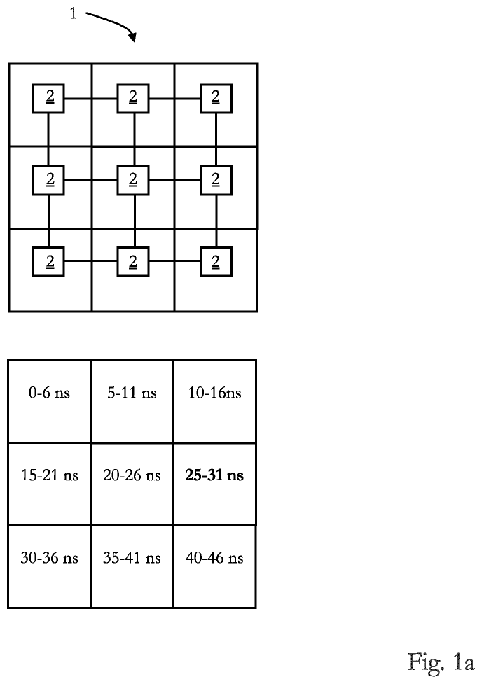

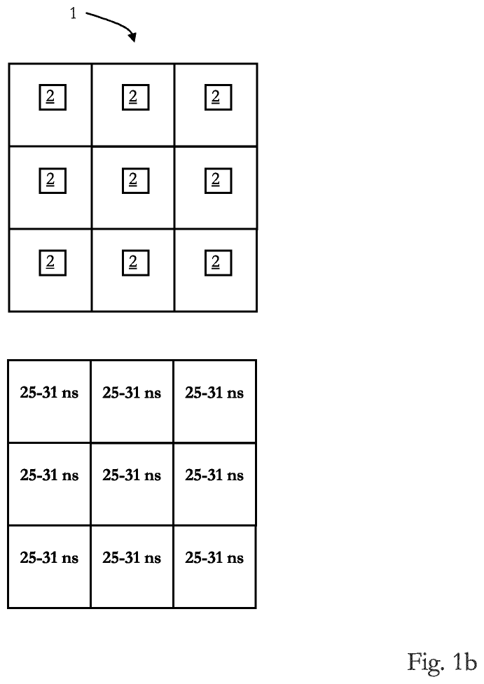

Before a detailed description of the embodiments starting with FIG. 1 is given, general explanations are made.

As mentioned in the outset, ToF devices are generally known.

iToF sensors may have larger resolution than dToF sensors since small pixels may be used, but iToF sensors may have a lower performance in high ambient light conditions (e.g. SNR (signal-to-noise ratio) is too low, i.e. high noise; high power consumption), whereas dToF sensors have a better SNR, but the pixel size may be larger and thus, a resolution may be lower. Moreover, if SPADs are used, dToF sensors may have a high power consumption due to histogramming. Additionally, an electric circuit may be larger than in the iToF case, and a high logic bandwidth may be needed. Furthermore, for deadtime compensation, multiple SPADs may be required for one pixel.

Moreover, known sensors may produce a certain amount of noise due to histogramming for which a plurality of time bins is filled with photon counts although these time bins do not necessarily correspond to the real time of flight (i.e. ambient light may be detected in such cases). For example, also in the dToF case, it might be challenging to have an SNR above three at full resolution and full range.

Hence, it has been recognized that it is desirable when only the relevant time bins of the histogram are taken into account, in particular in situations with high ambient light. In known dToF devices, for increasing the SNR, a resolution may be decreased, for example by making one ToF measurement with multiple pixels (i.e. a macropixel). However, it may be desirable to have both a high resolution and a high SNR.

Therefore, some embodiments pertain to time-of-flight light event detection circuitry configured to: determine, in a macropixel mode, for a first frame for a first predetermined time period, light events of light being incident on a first light detection element; determine, in the macropixel mode, for the first frame for a second predetermined time period, light events of light being incident on a second light detection element; and determine, in a window mode, based on the macropixel mode, for a second frame after the resulting first frame, a third time period, in which light events are to be detected.

In some embodiments every light detection element corresponds to one light event detection circuitry that can be configured for a certain timeframe. Such light event detection circuitry could be using for example CADTOF or histogramming. In some embodiments the light detection element size and the light detection element circuitry are same. In some embodiments the multiple event detection circuitry can be combined to obtain a measurement over a longer range, resulting in e.g. one larger histogram.

Circuitry may pertain to any entity or multitude of entities adapted to process light event data, such as a CPU (central processing unit), GPU (graphics processing unit), FPGA (field programmable gate array), a server, a camera, or the like, wherein also combinations of such entities may be envisaged by the skilled person, in some embodiments.

The circuitry may be configured to determine light events of light being incident on a first and a second light detection element. The light events on the first light detection element may be different from the light events on the second light detection element. For example, a number of light events may be different, an origin of the light events may be different, or the like.

The light events may be indicative of a reflection of a light pulse at a scene (e.g. an object, region of interest) which is reflected onto the first and the second light detection elements, such that it is incident on (a detection region of) the first and the second light detection element. Generally, it should be noted that, in some embodiments, there may be no light incident on one or both of the light detection elements, in which case no light events may be determined.

The light events may be determined for a first frame. A frame may correspond to a predetermined amount of time in which a measurement or detection is carried out. A frame length may be based on a maximum measurement distance, for example, or may be given arbitrarily.

As it is generally known in the field of ToF, for each frame, a histogram is generated based on a light event count, which is binned accordingly.

According to the present disclosure, within the first frame it may be determined for a first predetermined time period, whether light events (and how much light events) are incident on the first light detection element. Moreover, it may be determined for a second predetermined time period, whether (and how much) light events are incident on the second light detection element.

For example, for the first light detection element, it may be determined whether light is incident in the time range of zero to six nanoseconds after emission of the light pulse (which is to be reflected at the scene) and for the second light detection element, it may be determined whether light is incident in the time range of five to eleven nanoseconds after emission.

However, the present disclosure is not limited to only two light detection elements and two predetermined time periods. For example, a macropixel including nine light detection elements (or more or less) may be envisaged, for which light events in further predetermined time periods may be determined.

In such configurations, a histogram is generated. In the case of the two light detection elements as described above, a first number of light events may be determined for the first light detection element, and a second number of light events may be determined for the second light detection element.

If one of the numbers of light events is (significantly) higher than the other, it may be determined that the time of flight (which the light needs from emission to being incident on the light detection elements or image sensor) lies within the time period for which more events have been determined.

In the case of more than two light detection elements, such that a more complex histogram can be generated, several time periods can be determined, for example, if a peak in the histogram is distributed across the several time periods. However, the present disclosure is not limited to a peak since any other predetermined histogram feature (e.g. a dip) may be determined. Hence, a time period can be determined for which a next determination of light events is carried out. For example, in the case of two predetermined time periods, the time period for which more events have been detected can be further split up (or refined) and a finer measurement can be carried out.

For example, a first measurement may be carried out with two macropixels (as two light detection elements) of eighty-one subpixels (light detection elements) each. For the macropixel for which more events have been detected, a finer measurement is carried out, for example based on nine times nine sub-macropixels, which can further be refined based on three time three sub-macropixels, or the like.

In some embodiments, it is determined that the time period in which more events have been detected should be the time period for which light events for both light detection elements should be determined.

In other words, in some embodiments, the ToF light event detection circuitry is further configured to determine, for a second frame after the resulting first frame, a third time period based on the resulting first frame, in which light events are to be detected.

The present disclosure is not limited to the third time period being applied to the first or second light detection element, but may be applied to another (third) light detection element.

Hence, in the second frame (after the resulting first frame), the time period is defined such that the reflected light pulse is detected more exactly. Hence, background noise is reduced since the total detection time corresponds to the third time period in which the light pulse is incident on the respective light detection element and not the full detection time range.

In some embodiments, the third time period corresponds to one of the first and the second time periods for which more light events have been determined, as discussed herein.

In some embodiments, the first and the second light detection elements include a single photon avalanche diode (SPAD).

However, the present disclosure is not limited to SPADs, as any type of light detection element may be envisaged, which can be configured to count photons or determine light events, as discussed herein, such as an avalanche photodiode (APD) or any other type of photodiode.

The SPADs (or any other photodiodes) may be provided on a semiconductor substrate which may be stacked to a logic die, for example.

In some embodiments, the light events are determined based on at least one histogram, as discussed herein. Multiple histograms may be used and may be fused together, for example if they derive from multiple (macro) pixels.

In some embodiments, the light events are determined based on at least two phase-shifted readout signals.

The two readout signals may be phase-shifted with respect to each other. For example, a first readout signal may have a predetermined signal shape (e.g. rectangular, triangular, sawtooth, sine, or the like) and the second readout signal may have the same shape, but another phase (e.g. ninety degrees phase-shifted with respect to the first readout signal).

The two readout signals may be applied to parallel signal paths of each light detection element which should be read and may be applied at the corresponding predetermined time period. Hence, due to a readout amplitude, it can be determined whether a light event has been generated, i.e. whether lock has taken place.

In some embodiments, the third time period is determined based on a peak in the at least one histogram, as discussed herein.

In some embodiments, the third time period is determined for at least one of the first and the second light detection elements, as discussed herein.

In some embodiments, the third time period is determined for the first and the second light detection elements, and the third time period corresponds to the time period of the first and the second time periods for which more light events have been determined, as discussed herein.

In some embodiments, the third time period is determined for a third light detection element, as discussed herein, wherein the third light detection element differs from the first and the second light detection elements.

In some embodiments, in the second frame, the light events of the first and the second light detection elements are determined for the first and the second time periods in the first frame.

Hence, the first and/or the second light detection elements may detect light events during a larger exposure time than the third light detection element, which makes it possible to detect changes in a distance by the first and/or the second light detection elements, such that the third time period for the third light detection element can be adapted accordingly.

In some embodiments, in the window mode, at least one of the first and the second light detection elements are quenched, as will be discussed below.

In some embodiments, the circuitry is further configured to: determine, for a third frame after the second frame, in the macropixel mode, a fourth time period, if a number of light events is below a predetermined threshold in the second frame, for carrying out the window mode in a fourth frame after the third frame.

Hence, in such cases, the time period in which the window mode is carried out, may be dynamically adapted frame for frame.

In some embodiments, the circuitry is further configured to: optimize a window of the window mode for following a pulse peak location and/or a pulse peak location.

Hence, in such embodiments, it may not be necessary to switch back to the macropixel mode, if the window or the peak can be tracked.

In some embodiments, the time-of-flight event detection circuitry further includes a plurality of light detection elements including the first and the second light detection element, the circuitry being further configured to: group a first subset of the plurality of light detection elements for carrying out the macropixel mode; and group a second subset of the plurality of light detection elements for carrying out the window mode.

The first and the second subset may have common light detection elements or may be disjunct. If they are disjunct, both modes may be carried out in parallel, for example.

Some embodiments pertain to a time-of-flight light event detection method including: determining, in a macropixel mode, for a first frame for a first predetermined time period, light events of light being incident on a first light detection element; determining, in the macropixel mode, for the first frame for a second predetermined time period, light events of light being incident on a second light detection element; and determining, in a window mode, based on the macropixel mode, for a second frame after the resulting first frame, a third time period, in which light events are to be detected, as discussed herein.

The ToF light event detection method may be carried out with ToF light event detection circuitry according to the present disclosure.

In some embodiments, the third time period corresponds to the time period of the first and the second time periods for which more light events have been determined, as discussed herein. In some embodiments, the first and the second light detection elements include a single photon avalanche diode, as discussed herein. In some embodiments, the light events are determined based on at least one histogram, as discussed herein. In some embodiments, the light events are determined based on at least two phase-shifted readout signals, as discussed herein. In some embodiments, the third time period is determined based on a peak in the at least one histogram, as discussed herein. In some embodiments, the third time period is determined for at least one of the first and the second light detection elements, as discussed herein. In some embodiments, the third time period is determined for the first and the second light detection elements, and wherein the third time period corresponds to the time period of the first and the second time periods for which more light events have been determined, as discussed herein. In some embodiments, the third time period is determined for a third light detection element, as discussed herein. In some embodiments, in the second frame, the light events of the first and the second light detection elements are determined according to the first and the second time periods in the first frame, as discussed herein. In some embodiments, in the window mode, at least one of the first and the second light detection elements are quenched, as discussed herein. In some embodiments, the method further includes: determining, for a third frame after the second frame, in the macropixel mode, a fourth time period, if a number of light events is below a predetermined threshold in the second frame, for carrying out the window mode in a fourth frame after the third frame, as discussed herein. In some embodiments, the method further includes: optimizing a window of the window mode for following a pulse location and/or a pulse peak location, as discussed herein. In some embodiments, the method is carried out for a plurality of light detection elements including the first and the second light detection element, the method further including: grouping a first subset of the plurality of light detection elements for carrying out the macropixel mode; and grouping a second subset of the plurality of light detection elements for carrying out the window mode, as discussed herein.

Some embodiments pertain to a ToF sensor including an array of SPADs configuring a plurality of macropixels, the ToF sensor being configured to: acquire a first frame, based on an avalanche signal, which is representative of a light detection event or a plurality of light detection events; process the first frame in order to determine a time interval; acquire a second frame, based on a further avalanche signal, which is representative of a further light detection event or a further plurality of light detection events; and process the second frame in order to determine a distribution of avalanche signals assigned to each portions of the macropixels.

In some embodiments, the macropixels include a plurality of pixels and each pixel is configured to count a number of detected photons.

In some embodiments, a histogram is generated for each macropixel.

In some embodiments, the time interval covers a high density of avalanche signals (observed in the first frame).

In some embodiments, the second frame is acquired based on the determined time interval by using portions of the macropixels, wherein the portions include individual pixels or sub-macropixels.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is depicted, in FIG. 1a, an image sensor 1 including a plurality of light detection elements 2, which are implemented as SPADs, in this embodiment. The SPADs 2 are arranged on a three times three grid (also referred to as array, in some embodiments) and define a macropixel. Lines between the SPADs 2 indicate that the SPADs 2 are used together as a macropixel, i.e. any PADS 2 event will be processed the same way as if the macropixel works as one big SPAD, such that, using the circuitry provided per SPAD for any SPAD a full range histogram with a selected time interval can be generated as described here under.

Each SPAD has a corresponding circuit recording SPAD events in an histogram or another read-out mechanism, such as a CADTOF circuit. Each circuit may be configured to receive events in a certain time window, as can be taken from the bottom of FIG. 1a indicating the different time periods. In that case events from any SPAD 2 triggering in the macropixel are recorded in the corresponding circuit depending on a time of trigger.

The upper left circuit's time period is zero to six nanoseconds, the upper middle circuit's time period is five to eleven nanoseconds, the upper right circuit's time period is ten to sixteen nanoseconds. The middle left circuit's time period is fifteen to twenty-one nanoseconds, the middle mid circuit's time period is twenty to twenty-six nanoseconds, the middle right circuit's time period is twenty-five to thirty-one nanoseconds. The lower left circuit's time period is thirty to thirty-six nanoseconds, the lower middle circuit's time period is thirty-five to forty-one nanoseconds, the lower right circuit's time period is forty to forty-six nanoseconds.

In this example, a one nanosecond overlap between the time windows is adopted, such that a suitable measurement can be carried out when the pulse is located at the timing edge of the window. This may also allow to smoothly transition from one window to a next window which may be considered as a refinement step to follow the pulse in case of changing distance over time. Typically the overlap should be smaller or equal to the pulse length of the illumination.

The circuits all record histograms or CADTOF I/Q outputs of light events being incident on them in their respective predetermined time period. In this example in the middle right SPAD's time period in the histogram (i.e., in the respective histogram bin), a peak has been determined.

Accordingly, as shown in FIG. 1b, in a next (second) frame, all circuits' time periods are configured in window mode and in this example, determined to be twenty-five to thirty-one nanoseconds and the SPADs 2 are not used as a macropixel anymore. In this way, each individual SPAD outputs it events to a corresponding circuit with the time period identified in the first frame as containing most pulse return events.

Several effects may be derived from that.

As a first exemplary effect, the spatial resolution is increased nine times with respect to the first frame since it has been determined in which time bin the reflected light will arrive, such that a fine measurement can be carried out.

As a second exemplary effect, the SPAD devices are kept quenched outside the identified window, so that SPAD power, consumed at every trigger, is saved. Thirdly, less ambient or DCR events are recorded, which can typically cause higher noise in the eventual read-out of the distance, for example in a CADTOF circuit.

In some embodiments, frames according to FIG. 1a and/or FIG. 1b alternate. However, in other embodiments, frames are recorded based on FIG. 1b, in the window mode and only every predetermined number of frames are recorded according to FIG. 1a. As long as distance changes in the pixel(s) are minimal, it may be considered as uneconomic to utilize the macropixel mode according to FIG. 1a recording a longer distance range, in this example from zero to forty-six nanoseconds. This could also be decided and configured per group or subset of pixels, having in one imager some pixels run in window mode, and some in macropixel mode.

In some embodiments, it could also be decided to keep the macropixel working as one interconnected SPAD, where all events of any SPAD are processed in the same way, but combined with window mode, wherein the SPADS are focused only at the earlier detected peak location window and quenched outside this range.

In some embodiments, it is decided/detected at every window frame read-out whether to go use the macropixel mode by comparing the number of events in each circuit over time confirming signal intensity is sufficient inside the used window, and/or by following at each read-out if the pulse location is sufficiently inside the configured window. Alternatively, if the pulse location approaches the side of the window, it is decided, in some embodiments, to adjust the configured window to again safely include the pulse instead of switching to macropixel mode and re-measuring the pulse location over the full range.

FIG. 2 depicts a further embodiment of how the time periods for the SPADs 2 of the image sensor 1 can be configured and used. A set of SPADS, in this case the middle line, are configured with corresponding CADTOF at twenty megahertz, thereby enabling a longer read-out window, and further allowing these three SPADS at all times to record the longer distance range of zero to fifty nanoseconds.

The surrounding SPADS and circuits are, in some embodiments, configured based on the distance measurements taken with the middle three SPADS. In this way, the top and bottom row of SPADS function in window mode, giving more precise distance measurements, using less SPAD power, and giving per SPAD spatial resolution, while the middle row continuously indicates the overall pulse location, from which the window location for top and bottom can be derived.

FIG. 2 illustrates the concept using CADTOF and its corresponding frequencies of twenty megahertz (corresponding to the range of zero to fifty nanoseconds) and two-hundred megahertz (roughly corresponding to the range of twenty-five to thirty-one nanoseconds as determined in the first measurement of twenty MHz) (as exemplary frequencies in this embodiment).

However, in some embodiments, any coarser longer range, lower frequency for the middle three SPADS and then for the surrounding SPADs a per SPAD higher frequency focused on the window measured with the coarse frequency are used.

Also, instead of CADTOF, other approaches may be used like DTOF in which a histogram can be built. In that context, the skilled person may envisage obtaining a full coarse histogram with the middle 3 SPADs (of FIG. 2), and use the resulting peak information to configure a partial histogram per SPAD with the top and bottom row of SPADs, or the like, wherein the skilled person may adapt the embodiment accordingly without departing from the present disclosure.

Many alternative configurations may be thought of, e.g., wherein for each consecutive frame, the SPADS configured together at twenty megahertz vis-à-vis the SPADS configured at two-hundred megahertz as individual pixels may be changing so that all individual SPADS function at one point as an independent distance measurement and such that maximum robustness versus motion may be achieved, in some embodiments.

It should be noted that the respective time periods described with respect to FIGS. 1 and 2 are chosen only for exemplary purposes and can be changed accordingly depending on the circumstances. Furthermore, the present disclosure is not limited to a three times three grid as any connected or not-connected implementation of at least two light detection elements can carry out the methods of the present disclosure. For example, a macropixel may include eighty-one-pixels, defining nine sub-macropixels, or the like.

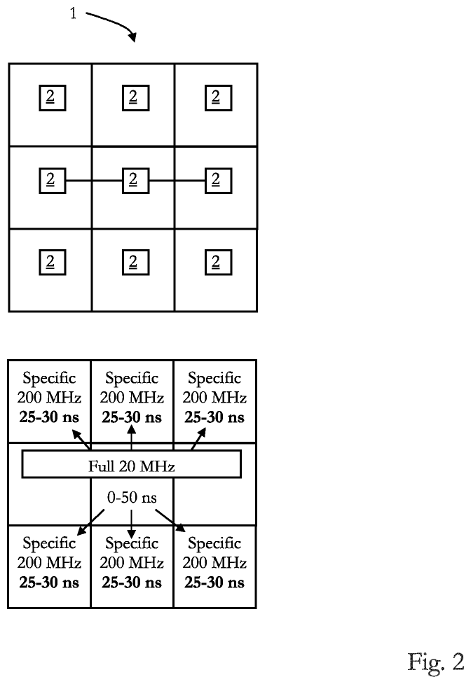

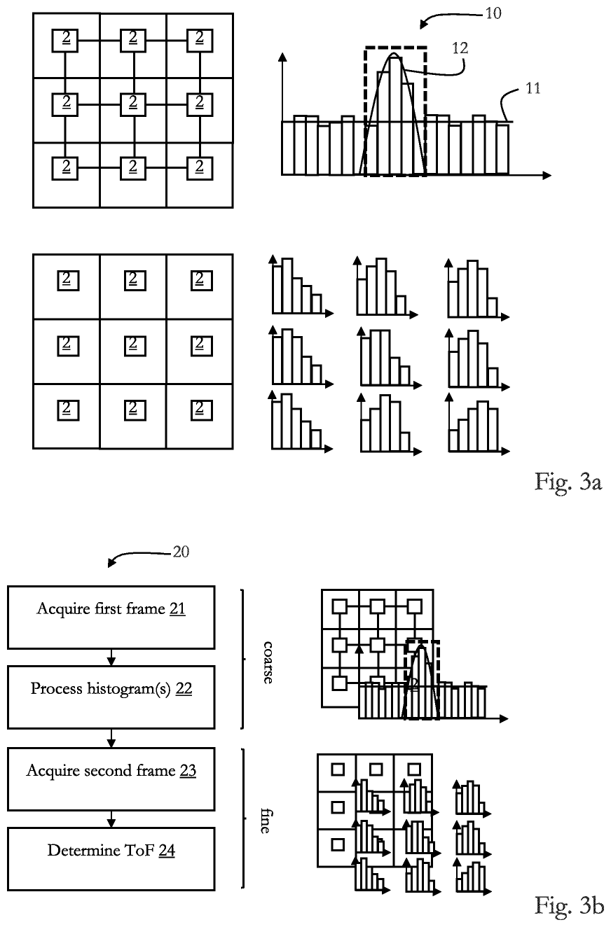

In FIG. 3a, the image sensor 1 as described with respect to FIG. 1 is shown. As depicted on top of FIG. 3a, in a first frame, a first histogram 10 is generated, wherein the histogram 10 has a time on the abscissa and a number of counts on the ordinate. The bin width of the histogram 10 corresponds to the respective predetermined time periods at which the single SPADs 2 of the image sensor 1 measure. A horizontal line 11 depicts a background noise which is a mean of the counts at the pixels at which the light pulse is not incident.

Moreover, the histogram includes a peak 12 and the bins (time periods) across which the peak is spread is determined as the third time period for the second frame.

Accordingly, on the bottom of FIG. 3a, a plurality of histograms is depicted, wherein each histogram is recorded with a single SPAD 2 in the second frame.

FIG. 3b depicts a time-of-flight light detection method 20 according to the present disclosure.

First, a coarse measurement is carried out in the first frame, and then, a fine measurement is carried out in a second frame.

At 21, a first frame is acquired in the macropixel in macropixel mode, as discussed herein (e.g. under reference of FIG. 3a).

At 22, the resulting histogram(s) is (are) processed, i.e. the background noise (or ambient light signal) and the peak are identified.

At 23, a second frame is acquired in window mode, as discussed herein (e.g. under reference of FIG. 3b). Thereby, for each individual SPAD, a partial histogram or CADTOF focused on the peak location identified in 22 is obtained.

At 24, the time of flight is determined for each sub-pixel based on the multiple histograms acquired at 23.

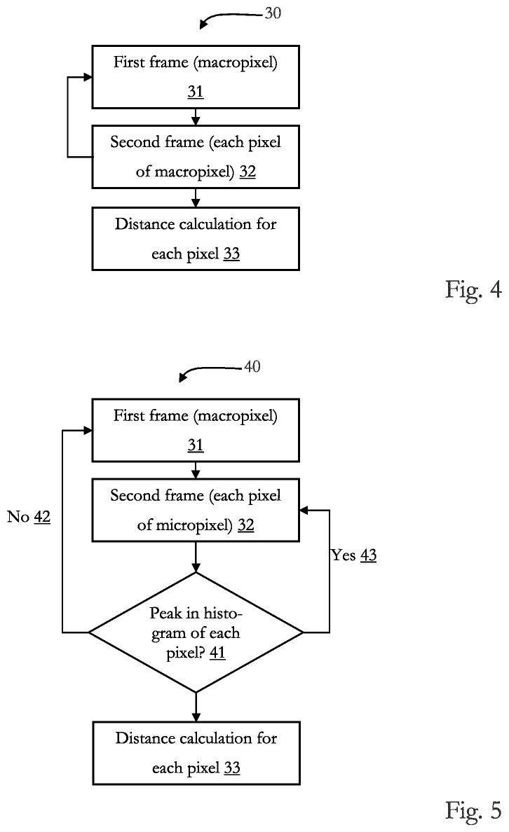

FIG. 4 depicts a further ToF light detection method 30 according to the present disclosure.

At 31, a first frame is acquired in a macropixel, as discussed herein.

At 32, a second frame is acquired for each pixel of the macropixel, as discussed herein.

At 33, a distance is calculated for each pixel of the macropixel, as discussed herein.

FIG. 5 depicts a further ToF light detection method 40 according to the present disclosure, which is different from the method 30 in that before the distance is calculated at 33, i.e. after the second frame 32, it is decided, at 41, whether each histogram includes a peak.

If not, at 42, a first frame is acquired again for the macropixel.

If yes, at 43, either a distance is calculated for each pixel, or the second frame is acquired again (e.g. as a third frame with further refined time periods).

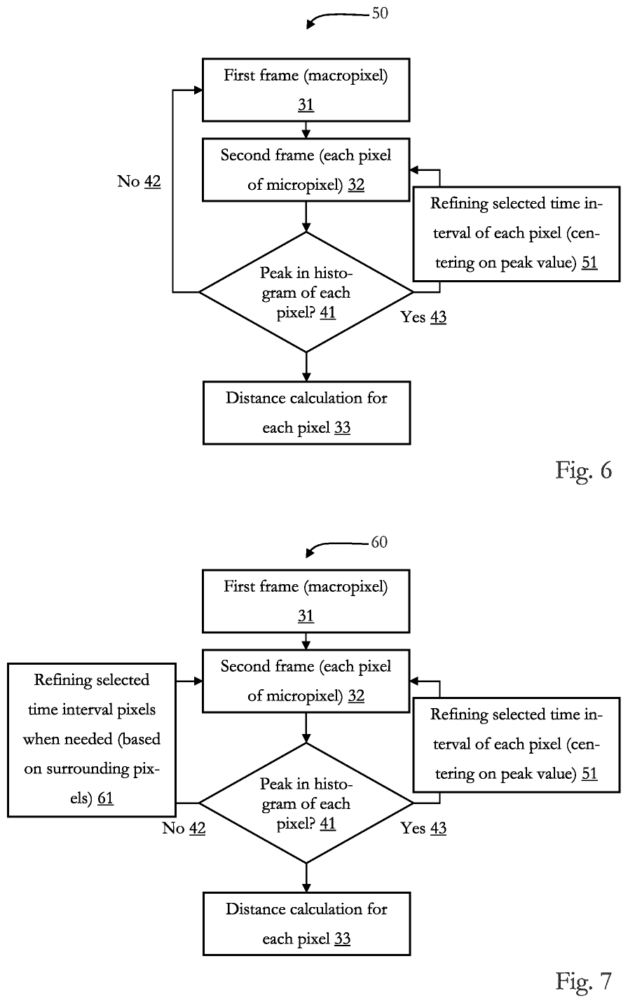

FIG. 6 depicts a further ToF light detection method 50 according to the present disclosure, which is different from the method 40 in that, if each histogram of each pixel has a peak, at 51, the selected time interval (i.e. the predetermined time period) is refined for each pixel in order to align the time interval of the next frame acquisition with the measured distance range.

FIG. 7 depicts a further ToF light detection method 60 according to the present disclosure, which is different from the method 50 in that, if not each histogram of each pixel has a peak, at 61, the time interval of those pixels is refined, which do not have a peak in the histogram, wherein the time intervals are refined based on surrounding/neighboring pixels.

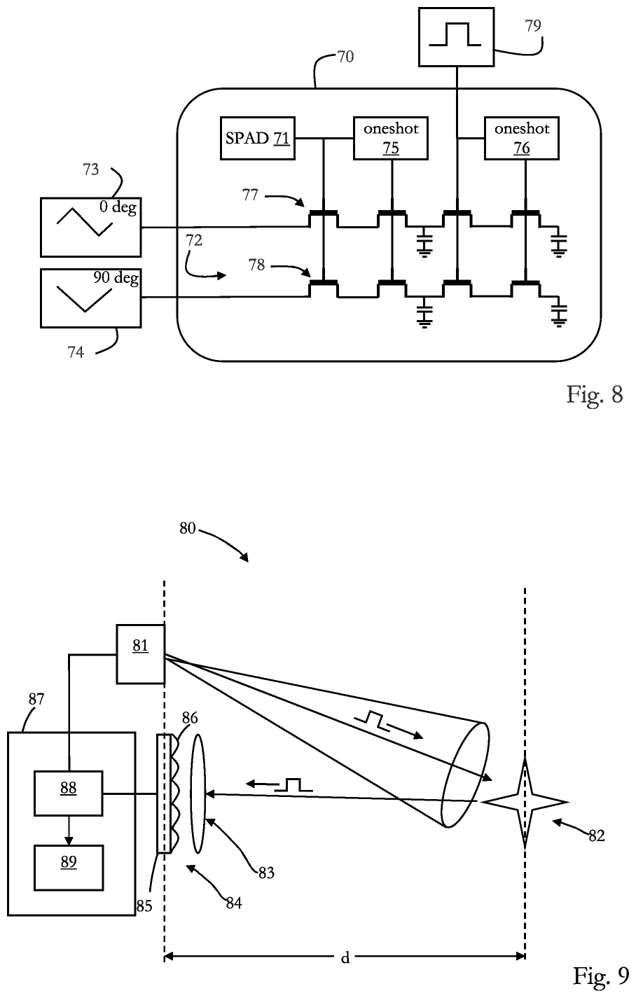

In FIG. 8, there is shown a conceptual diagram of a time-of-flight CADTOF (correlation assisted dToF) pixel 70 including a SPAD 71 and readout circuitry 72 including eight transistors, wherein four transistors are connected in a row by their sources and drains, and in parallel, four further transistors are connected in a row by their sources and drains. For understanding the basic principles of CADTOF, it is referred to European patent application EP20193730.7, which is hereby incorporated by reference.

After the second and fourth transistor of each row (seen from the left), capacities of each ten femto Farad are provided between the connection line of the transistors and ground, such that in total a capacitor size of forty femto Farad is present, which corresponds to roughly two square micrometers on a sensor, for example.

To the first transistor row, a first readout signal 73 is applied, which is a triangular voltage with a relative phase of zero degrees. A second readout signal 74 is applied to the second transistor row, which corresponds to the first readout signal 73, but is ninety degrees phase shifted with respect to the first readout signal 73.

Moreover, two “oneshot” circuits are provided, wherein a first oneshot circuit 75 is connected with the SPAD 71, such that it is aligned with a SPAD rate, with gates of the second transistors of the two transistor rows (seen from the left), and with a second oneshot circuit 76, which is aligned with a frame rate. The first oneshot circuit 75 is aligned with a rate of the SPAD.

The second oneshot circuit 76 is aligned with a framerate and is further connected with the fourth transistors of the two rows.

Generally, oneshot may refer to a pulse of a fixed duration from a pulse generator 79. Duration of a first pulse is ended before a second pulse takes place. Transistors 77 and 78 are closed (i.e., conducting), but at the moment the SPAD triggers, transistors 77 and 78 open. Transistors below oneshot 75 are open and are closed after opening of 77 and 78, but with a delay.

The two first columns of transistors from the left allow to average several SPAD events into the two (grounded) capacitors (in the middle), such that oneshot 75 is aligned with a SPAD rate.

The two columns of capacitors from the right allow to average the signal over a predefined time duration for aligning the readout signal with a framerate.

In other embodiments, aligning the readout signal with the framerate is carried out outside of the sensor.

Moreover, the SPAD 71 and the oneshot circuit 75 are mutually connected with the gates of the first transistors of the two transistor rows, and the pulse generator 79 and oneshot circuit 76 is mutually connected with the gates of the third transistors of the transistor rows.

In FIG. 9, on a high level, there is illustrated an embodiment of a time-of-flight imaging system 80, which is embodied here as a ToF camera and which can be used for depth sensing or providing a distance measurement and which has time-of-flight light detection circuitry 87 which is configured to perform the methods as discussed herein and which forms a control of the ToF apparatus 80 (and it includes, not shown, corresponding processors, memory and storage as it is generally known to the skilled person).

The ToF imaging system 80 has a pulsed light source 81 and it includes light emitting elements (based on laser diodes), wherein in the present embodiment, the light emitting elements are narrow band laser elements.

The light source 81 emits pulsed light to a scene 82 (region of interest or object), which reflects the light. By repeatedly emitting light to the scene 82, the scene 82 can be scanned, as it is generally known to the skilled person. The reflected light is focused by an optical stack 83 to a light detector 84.

The time-of-flight light detection circuitry 87 also forms control of the light source, such that it also includes a corresponding control circuitry (not depicted).

The light detector 84 has an image sensor 85, which is implemented based on multiple SPADs (Single Photon Avalanche Diodes) formed in an array of pixels (imaging elements) and a microlens array 86 which focuses the light reflected from the scene 82 to the image sensor 85 (to each pixel of the image sensor 85).

The light emission time information is fed from the light source 81 to the time-of-flight light detection circuitry 87 including a time-of-flight measurement unit 88, which also receives respective time information from the image sensor 85, when the light is detected which is reflected from the scene 82. On the basis of the emission time information received from the light source 81 and the time of arrival information received from the image sensor 85, the time-of-flight measurement unit 88 computes a round-trip time of the light emitted from the light source 81 and reflected by the scene 82 and on the basis thereon it computes a distance d (depth information) between the image sensor 85 and the scene 82 based on a determination of light events, as discussed herein.

The depth information is fed from the time-of-flight measurement unit 88 to a 3D image reconstruction unit 89 of the time-of-flight light detection circuitry 87, which reconstructs (generates) a 3D image of the scene 82, based on the depth information received from the time-of-flight measurement unit 88.

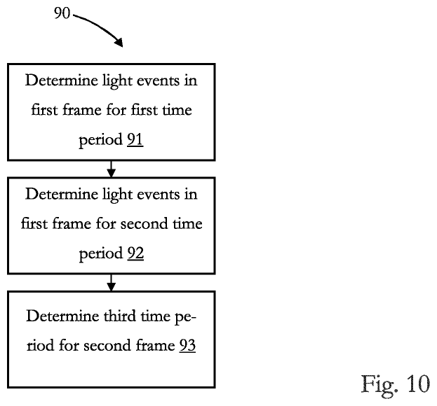

FIG. 10 depicts a further embodiment of a ToF light detection method 90 according to the present disclosure.

At 91, for a first frame for a first predetermined time period, light events of light being incident on a first light detection element are determined, as discussed herein.

At 92, for the first frame for a second predetermined time period, light events of light being incident on a second light detection element are determined, as discussed herein.

At 93, for a second frame after the resulting first frame, a third time period based on the resulting first frame is determined, in which lights events are to be detected.

It should be recognized that the embodiments describe methods with an exemplary ordering of method steps. The specific ordering of method steps is however given for illustrative purposes only and should not be construed as binding. For example, the ordering of 91 and 92 in the embodiment of FIG. 10 may be exchanged. Other changes of the ordering of method steps may be apparent to the skilled person.

Please note that the division of the ToF light detection circuitry 87 into units 88 and 89 is only made for illustration purposes and that the present disclosure is not limited to any specific division of functions in specific units. For instance, the circuitry 87 could be implemented by a respective programmed processor, field programmable gate array (FPGA) and the like.

In some embodiments, also a non-transitory computer-readable recording medium is provided that stores therein a computer program product, which, when executed by a processor, such as the processor described above, causes the methods described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) Time-of-flight light event detection circuitry configured to:
   determine, in a macropixel mode, for a first frame for a first predetermined time period, light events of light being incident on a first light detection element;
   determine, in the macropixel mode, for the first frame for a second predetermined time period, light events of light being incident on a second light detection element; and
   determine, in a window mode, based on the macropixel mode, for a second frame after the resulting first frame, a third time period, in which light events are to be detected.
(2) The time-of-flight event detection circuitry of (1), wherein the third time period corresponds to one of the first and the second time periods for which more light events have been determined.
(3) The time-of-flight light event detection circuitry of (1) or (2), wherein the first and the second light detection elements include a single photon avalanche diode.
(4) The time-of-flight light event detection circuitry of (3), wherein the light events are determined based on at least one histogram.
(5) The time-of-flight event detection circuitry of (3) or (4), wherein the light events are determined based on at least two phase-shifted readout signals.
(6) The time-of-flight event detection circuitry of (4) or (5), wherein the third time period is determined based on a peak in the at least one histogram.
(7) The time-of-flight light event detection circuitry of anyone of (1) to (6), wherein the third time period is determined for at least one of the first and the second light detection elements.
(8) The time-of-flight light event detection circuitry of anyone of (1) to (7), wherein the third time period is determined for the first and the second light detection elements, and wherein the third time period corresponds to the time period of the first and the second time periods for which more light events have been determined.
(9) The time-of-flight light event detection circuitry of anyone of (1) to (8), wherein the third time period is determined for a third light detection element.
(10) The time-of-flight light event detection circuitry of (9), wherein, in the second frame, the light events of the first and the second light detection elements are determined for the first and the second time periods in the first frame.
(11) The time-of-flight event detection circuitry of anyone of (1) to (10), wherein, in the window mode, at least one of the first and the second light detection elements are quenched.
(12) The time-of-flight event detection circuitry of anyone of (1) to (11), further configured to:
   determine, for a third frame after the second frame, in the macropixel mode, a fourth time period, if a number of light events is below a predetermined threshold in the second frame, for carrying out the window mode in a fourth frame after the third frame.
(13) The time-of-flight event detection circuitry of anyone of (1) to (12), further configured to:
   optimize a window of the window mode for following a pulse location and/or a pulse peak location.
(14) The time-of-flight event detection circuitry of anyone of (1) to (13), further comprising a plurality of light detection elements including the first and the second light detection element, the circuitry being further configured to:
   group a first subset of the plurality of light detection elements for carrying out the macropixel mode; and
   group a second subset of the plurality of light detection elements for carrying out the window mode.
(15) A time-of-flight light event detection method comprising:
   determining, in a macropixel mode, for a first frame for a first predetermined time period, light events of light being incident on a first light detection element;
   determining, in the macropixel mode, for the first frame for a second predetermined time period, light events of light being incident on a second light detection element; and
   determining, in a window mode, based on the macropixel mode, for a second frame after the resulting first frame, a third time period, in which light events are to be detected.
(16) The time-of-flight event detection method of (15), wherein the third time period corresponds to one of the first and the second time periods for which more light events have been determined.
(17) The time-of-flight light event detection method of (15) or (16), wherein the first and the second light detection elements include a single photon avalanche diode.
(18) The time-of-flight light event detection method of (17), wherein the light events are determined based on at least one histogram.
(19) The time-of-flight event detection method of (17) or (18), wherein the light events are determined based on at least two phase-shifted readout signals.
(20) The time-of-flight event detection method of (19) or (20), wherein the third time period is determined based on a peak in the at least one histogram.
(21) The time-of-flight light event detection method of anyone of (15) to (20), wherein the third time period is determined for at least one of the first and the second light detection elements.
(22) The time-of-flight light event detection method of anyone of (15) to (21), wherein the third time period is determined for the first and the second light detection elements, and wherein the third time period corresponds to the time period of the first and the second time periods for which more light events have been determined.
(23) The time-of-flight light event detection method of anyone of (15) to (23), wherein the third time period is determined for a third light detection element.
(24) The time-of-flight light event detection method of (23), wherein, in the second frame, the light events of the first and the second light detection elements are determined for the first and the second time periods in the first frame.
(25) The time-of-flight event detection method of anyone of (15) to (24), wherein, in the window mode, at least one of the first and the second light detection elements are quenched.
(26) The time-of-flight event detection method of anyone of (15) to (25), further comprising:
   determining, for a third frame after the second frame, in the macropixel mode, a fourth time period, if a number of light events is below a predetermined threshold in the second frame, for carrying out the window mode in a fourth frame after the third frame.
(27) The time-of-flight event detection method of anyone of (15) to (26), further comprising:
   optimizing a window of the window mode for following a pulse location and/or a pulse peak location.
(28) The time-of-flight event detection method of anyone of (15) to (27) being carried out for a plurality of light detection elements including the first and the second light detection element, the method further comprising:
   grouping a first subset of the plurality of light detection elements for carrying out the macropixel mode; and
   grouping a second subset of the plurality of light detection elements for carrying out the window mode.
(29) A computer program comprising program code causing a computer to perform the method according to anyone of (15) to (28), when being carried out on a computer.
(30) A non-transitory computer-readable recording medium that stores therein a computer program product, which, when executed by a processor, causes the method according to anyone of (15) to (28) to be performed.

1. Time-of-flight light event detection circuitry configured to:
determine, in a macropixel mode, for a first frame for a first predetermined time period, light events of light being incident on a first light detection element;
determine, in the macropixel mode, for the first frame for a second predetermined time period, light events of light being incident on a second light detection element; and
determine, in a window mode, based on the macropixel mode, for a second frame after the resulting first frame, a third time period in which light events are to be detected.

2. The time-of-flight event detection circuitry of claim 1, wherein the third time period corresponds to one of the first and the second time periods for which more light events have been determined.

3. The time-of-flight light event detection circuitry of claim 1, wherein the first and the second light detection elements include a single photon avalanche diode.

4. The time-of-flight light event detection circuitry of claim 3, wherein the light events are determined based on at least one histogram.

5. The time-of-flight event detection circuitry of claim 3, wherein the light events are determined based on at least two phase-shifted readout signals.

6. The time-of-flight event detection circuitry of claim 4, wherein the third time period is determined based on a peak in the at least one histogram.

7. The time-of-flight light event detection circuitry of claim 1, wherein the third time period is determined for at least one of the first and the second light detection elements.

8. The time-of-flight light event detection circuitry of claim 1, wherein the third time period is determined for the first and the second light detection elements, and wherein the third time period corresponds to the time period of the first and the second time periods for which more light events have been determined.

9. The time-of-flight light event detection circuitry of claim 1, wherein the third time period is determined for a third light detection element.

10. The time-of-flight light event detection circuitry of claim 9, wherein, in the second frame, the light events of the first and the second light detection elements are determined for the first and the second time periods in the first frame.

11. The time-of-flight event detection circuitry of claim 1, wherein, in the window mode, at least one of the first and the second light detection elements are quenched.

12. The time-of-flight event detection circuitry of claim 1, further configured to:
determine, for a third frame after the second frame, in the macropixel mode, a fourth time period, if a number of light events is below a predetermined threshold in the second frame, for carrying out the window mode in a fourth frame after the third frame.

13. The time-of-flight event detection circuitry of claim 1, further configured to:
optimize a window of the window mode for following a pulse location.

14. The time-of-flight event detection circuitry of claim 1, further comprising a plurality of light detection elements including the first and the second light detection element, the circuitry being further configured to:
group a first subset of the plurality of light detection elements for carrying out the macropixel mode; and
group a second subset of the plurality of light detection elements for carrying out the window mode.

15. A time-of-flight light event detection method comprising:
determining, in a macropixel mode, for a first frame for a first predetermined time period, light events of light being incident on a first light detection element;
determining, in the macropixel mode, for the first frame for a second predetermined time period, light events of light being incident on a second light detection element; and
determining, in a window mode, based on the macropixel mode, for a second frame after the resulting first frame, a third time period, in which light events are to be detected.

16. The time-of-flight event detection method of claim 15, wherein the third time period corresponds to one of the first and the second time periods for which more light events have been determined.

17. The time-of-flight event detection method of claim 15, wherein, in the window mode, at least one of the first and the second light detection elements are quenched.

18. The time-of-flight event detection method of claim 15, further comprising:
determining, for a third frame after the second frame, in the macropixel mode, a fourth time period, if a number of light events is below a predetermined threshold in the second frame, for carrying out the window mode in a fourth frame after the third frame.

19. The time-of-flight event detection method of claim 15, further comprising:
optimizing a window of the window mode for following a pulse location.

20. The time-of-flight event detection method of claim 15 being carried out for a plurality of light detection elements including the first and the second light detection element, the method further comprising:
grouping a first subset of the plurality of light detection elements for carrying out the macropixel mode; and
grouping a second subset of the plurality of light detection elements for carrying out the window mode.
